(19) United States
(12) Patent Application Publication
(10) Pub. No.: US 2008/0024831 A1
(43) Pub. Date: Jan. 31, 2008

(54) IMAGE PROCESSING DEVICE AND IMAGE PROCESSING METHOD

(75) Inventor: Kenichi KAMADA, Fushimi-ku (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MURATA KIKAI KABUSHIKI KAISHA, Kyoto-shi (JP)

(21) Appl. No.: 11/828,783

(22) Filed: Jul. 26, 2007

(30) Foreign Application Priority Data
Jul. 27, 2006 (JP) 2006-204322

(51) Int. Cl. H04N 1/387

(52) U.S. Cl. 358/452

(57) ABSTRACT

An image processing method includes the steps of: taking 2 to a (k−2)-th power-bit data from each one line of four-line data stored in an input line buffer out of the input image data to acquire four partial image data; rearranging each of the acquired four partial image data in sequence of the same data having been fed into the input line buffer; storing each of the rearranged four partial image data in an SDRAM as a minimum access unit; reading out an intermediate image data stored in the SDRAM on a minimum access unit to minimum access unit basis; storing four-pixel data extracted from each of the four partial image data, which compose the read out data, in a corresponding line memory element to rotate the input image data by 90 degrees; and outputting the acquired four lines of line data as part of the output image data.

### CROSS-REFERENCE TO RELATED APPLICATIONS

This application claims priority under 35 U.S.C. 119 to Japanese Patent Application No. 2006-204322, filed on Jul. 27, 2006, which application is hereby incorporated by reference in its entirety.

### BACKGROUND OF THE INVENTION

1. Field of the Invention

The present invention relates to an image processing device that rotates an input image, having an information content of 1 bit for each pixel, by 90 degrees, and obtains an output image data, and particularly, relates to an improvement of a device and a method that obtain the output image data.

2. Description of Related Art

There are, in the art, known devices for rotating input image data. One conventional device reuses data already read in during the image rotation process, and thereby, reduces a frequency of access to a memory. Another conventional device rotates a selection of a Random Access Memory (RAM) successively for each line, and thereby, reduces a frequency of access to the RAM. Still another conventional device is provided with two image memories to thereby allow even image data of an original having a large information content to be reliably stored in the image memories.

### BRIEF SUMMARY OF THE INVENTION

The conventional techniques, however, require an additional memory to rotate the image. One of the conventional techniques, for example, requires a 512×512-word high speed memory and a group of 64×64 flip-flops. The conventional techniques have, in consequence, cost too much in manufacturing the devices.

The present invention provides an image processing device and an image processing method capable of easily rotating an image.

A first aspect of the present invention is directed to an image processing device that rotates an input image, having an information content of 1 bit for each pixel, by 90 degrees, and obtains output image data. The image processing device includes: a Synchronous Dynamic Random Access Memory (SDRAM) including a minimum access unit, a data amount of the minimum access unit being 2 to the k-th power bits; an input line buffer capable of storing input image data on a four lines by four lines basis; a first image conversion unit that generates intermediate image data on a basis of the input image data stored in the input line buffer to store the generated intermediate image data in the SDRAM; an output line buffer including four line memory elements and being capable of storing output image data on a four lines by four lines basis; and a second image conversion unit that generates four lines of the output image data on the basis of the intermediate image data stored in the SDRAM to make the output line buffer output the output image data on a four lines by four lines basis.

According to a second aspect of the present invention, the SDRAM is a Double Data Rate (DDR) SDRAM, and a data amount of the minimum access unit is 2 to the 6-th power bits.

According to a third aspect of the present invention, the output line buffer includes a first output line buffer and a second output line buffer. The second output line buffer is capable of outputting data while data is written in the first output line buffer. The first output line buffer is capable of outputting data while data is written in the second output line buffer.

According to the first aspect of the present invention, the first image conversion unit acquires partial image data having a data amount of 2 to the (k−2)-th power bits from each one line of four-line data stored in the input line buffer out of the input image data. Subsequently, the first image conversion unit stores the acquired partial image data in the SDRAM as the minimum access unit. Thus, the first image conversion unit stores the intermediate image data generated on the basis of the input image data in the SDRAM.

On the other hand, the second image conversion unit reads out the intermediate image data stored in the SDRAM on a minimum access unit to minimum access unit basis. Here, the read out data includes four partial image data. Thereafter, the second image conversion unit, by use of the four line memory elements, rotates the image on the basis of four-pixel (i.e., four-bit) data extracted from each of the read out four partial image data.

The present invention, therefore, effectively utilizes 4×4 (i.e., 16 bits) data out of 2 to the k-th bits data read out from the SDRAM during the image rotation, and improves the utilization efficiency of the read out data. Further, the present invention advantageously reduces the memory capacities required for the image rotation.

Therefore, the present invention can advantageously reduce a frequency of reading out the data from each one of the minimum access units, and also reduce the costs of manufacturing the device.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a diagram illustrating an example of a structure of an image processing device according to a preferred embodiment of the present invention;

FIG. 2 is a diagram schematically illustrating image data recorded on a recording sheet;

FIG. 3 is a diagram schematically illustrating image data recorded on a recording sheet;

FIG. 4 is a flowchart illustrating procedures of generating intermediate image data from input image data;

FIG. 5 is a diagram illustrating an example of line data stored in an input line buffer;

FIG. 6 is a diagram illustrating an example of data to be stored in a minimum access unit in an SDRAM;

FIG. 7 is a diagram illustrating an example of line data stored in the input line buffer;

FIG. 8 is a diagram illustrating an example of data to be stored in the minimum access unit in the SDRAM;

FIG. 9 is a diagram illustrating an example of a logical address space in the SDRAM;

FIG. 10 is a flowchart illustrating procedures of generating output image data from intermediate image data;

FIG. 11 is a diagram illustrating an example of data read out from the SDRAM;

FIG. 12 is a diagram illustrating an example of line data stored in an output line buffers;

FIG. 13 is a diagram illustrating an example of data read out from the SDRAM; and

FIG. 14 is a diagram illustrating an example of line data stored in the output line buffers.

### DETAILED DESCRIPTION OF PREFERRED EMBODIMENTS

Preferred embodiments of the present invention will, hereinafter, be described in detail with reference to accompanying figures.

(1. Structure of Image Processing Device)

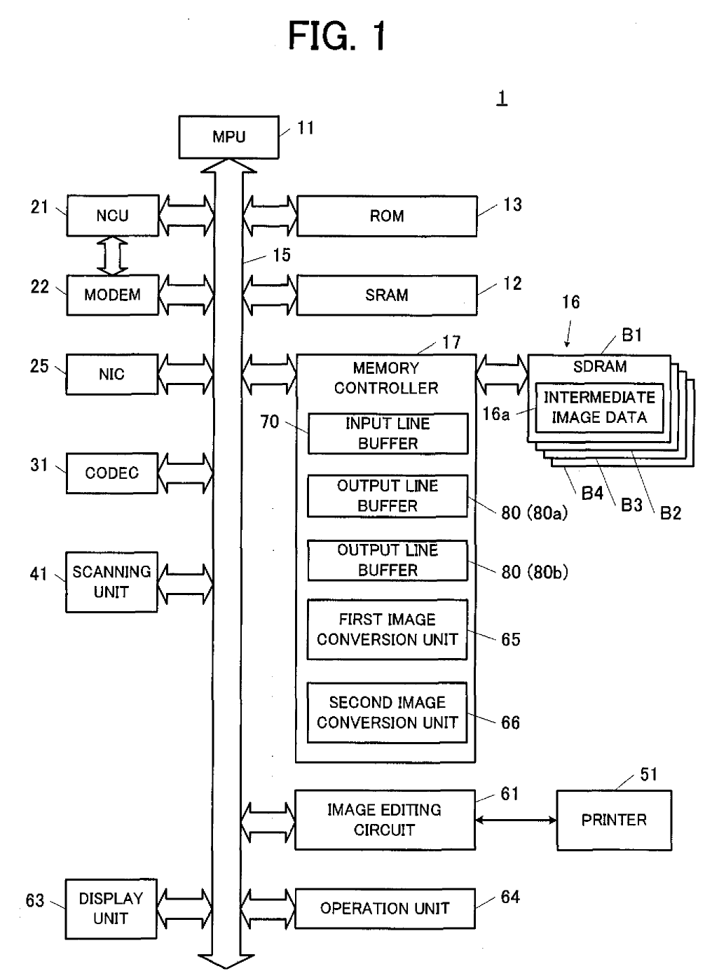

FIG. 1 is a diagram illustrating an example of a structure of an image processing device 1 according to one of the preferred embodiments of the present invention. The image processing device 1 is, for example, a scanner, a printer, a copier, a facsimile, or a Multi-Function-Peripheral that combines these functions. The image processing device 1 is capable of rotating an input image by 90 degrees and outputting the rotated image. Here, the image data is bi-level one.

As illustrated in FIG. 1, the image processing device 1, as its major part, includes a Micro Processing Unit (MPU) 11, a Synchronous Dynamic Random Access Memory (SDRAM) 16, a Memory Controller 17, a Coder and Decoder (CODEC) 31, a Scanning Unit 41, a printer 51, and an image editing circuit 61.

A Modulator and Demodulator (MODEM) 22 converts digital data (i.e., image data) to an Audio Frequency Signal, and further converts an Audio Frequency Signal received by the image processing device 1 to digital data. A Network Control Unit (NCU) 21 is a device used for connecting the image processing device 1 with the Public Switched Telephone Network. The NCU 21 transmits an address signal and detects a Ringing. A Network Interface Card (NIC) 25 is a Local Area Network (LAN) interface, which performs data communication with Information Processing devices (not illustrated) and the like connected via the network.

The CODEC 31 is used for loss-less compression of image data to be transmitted in facsimile communication. The CODEC 31, for example, encodes image data that has been read from an original and converted to bi-level image data by the scanning unit 41. The encoded image data is stored in SDRAM 16 as intermediate image data 16a. The CODEC 31 further decodes encoded image data, which has been received from another image processing device and stored in the SDRAM 16, to bi-level image data.

The CODEC 31 employs any one of Modified Huffman (MH), Modified Read (MR), Modified MR (MMR) and Joint Bi-level Image experts Group (JBIG) as a coding system.

The Scanning Unit 41 is a reading unit for reading image data from the original. The image data read by the Scanning Unit 41 is compressed on the basis of Joint Photographic Coding Experts Group (JPEG), for example, and is thereafter stored in the SDRAM 16.

The printer 51 employs an electrophotography method to record a toner image, derived from an electrostatic latent image, on a recording sheet. The printer 51, for example, forms a toner image, based on the image data read by the scanning unit 41, on a photosensitive drum (not illustrated) and transfers the toner image onto the recording sheet.

The image editing circuit 61 performs processing, such as smoothing or resolution conversion, to uncompressed image data (i.e., bit-mapped bi-level image data). The processed image data is supplied to the printer 51 as a serial data row.

A display unit 63, provided with a Liquid Crystal Display, functions as a touch screen, which allows a user of the image processing device 1 (hereinafter, simply referred to as a “user”) to touch a specific position on the screen directly or via a dedicated stylus to instruct the position. Accordingly, the user, watching a guidance indicated on the display unit 63, can use the “touch screen” on the display unit 63 to instruct the image processing device 1 to perform a desired function. Thus, the display unit 63 can be used as an input unit.

An operation unit 64 is an input unit composed of so-called, a keypad. The user operates the operation unit 64 in accordance with the indication on the display unit 63 to instruct the image processing device 1 to perform a desired function.

A Static Random Access Memory (SRAM) 12 is a memory unit provided with flip-flops as memory cells. The SRAM 12 is, for example, used as a memory for storing user registration information (e.g., one-touch-dial information). The SRAM 12 operates at a high speed and requires no memory refreshing operation.

The SDRAM 16, which is a rewritable volatile memory (a memory unit), transfers data in synchronization with a periodical clock signal. A volume of data transferred at once to and from the SDRAM 16 is 2 to the k-th power bits (here, k is a natural number). The data volume of each minimum access unit in the SDRAM 16 is, therefore, 2 to the k-th power bits.

The SDRAM 16 has a plurality of (e.g., four in the present embodiment) banks B1 to B4, and is capable of storing the intermediate image data 16a, which is generated on the basis of the input image data.

The present preferred embodiment employs a Double Data Rate (DDR) SDRAM as the SDRAM 16, which transfers data of 2 to the 6th bits at once (here, k is assumed equal to 6).

The memory controller 17, for example, controls data transfer between a data processing unit (e.g., the CODEC 31 or the image editing circuit 61) for performing a specified processing for image data and the SDRAM 16. As illustrated in FIG. 1, the memory controller 17 is provided with an input line buffer 70, output line buffers 80, the first image conversion unit 65 and the second image conversion unit 66.

Here, the image processing device 1 according to the present embodiment includes two output line buffers 80 (i.e., 80a and 80b), which are similar to each other in a hardware structure. While one of the output line buffers 80 is supplied with data, the other one can output data. The input line buffer 70 and the output line buffers 80 will be described in more detail later.

The first image conversion unit 65 generates the intermediate image data 16a on the basis of the input image data stored in the input line buffer 70. The first image conversion unit 65 further stores the generated intermediate image data 16a in the SDRAM 16.

The second image conversion unit 66 generates four lines of output image data on the basis of the intermediate image data 16a stored in the SDRAM 16, and makes the output line buffers 80 output the generated output image data on a four lines by four lines basis.

There will later be described procedures in which the first image conversion unit 65 generates the intermediate image data from the input image data, and the second image conversion unit 66 generates the output data from the intermediate image data.

The MPU 11 performs a control according to a program stored in a Read Only Memory (ROM) 13. The MPU 11, the ROM 13, the memory controller 17, the CODEC 31, the image editing circuit 61 and others are electrically connected with each other via a signal line 15. Therefore, the MPU 11 can, for example, control the CODEC 31 to perform the coding and the memory controller 17 to transfer the data, at specified time.

(2. Rotation Procedures of Image)

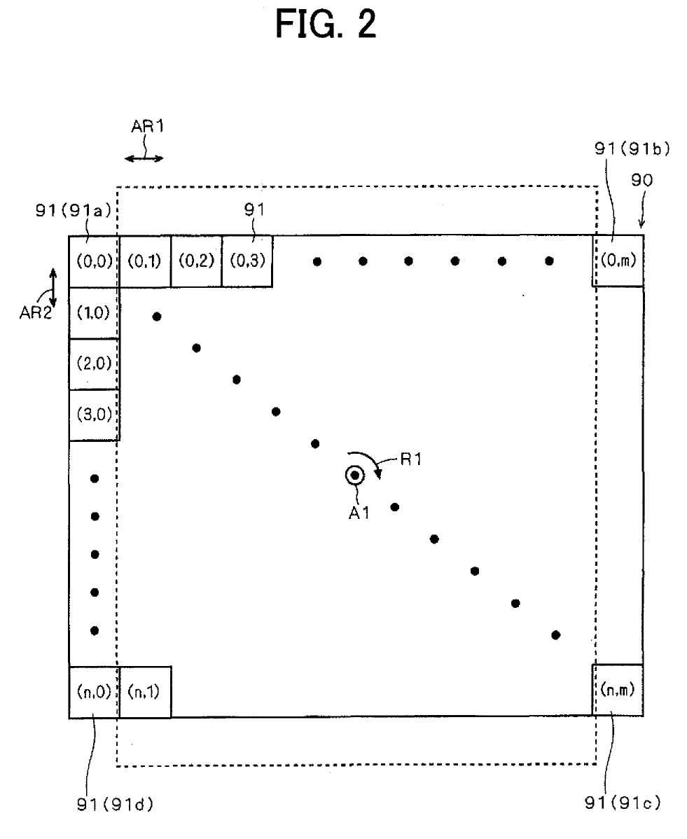

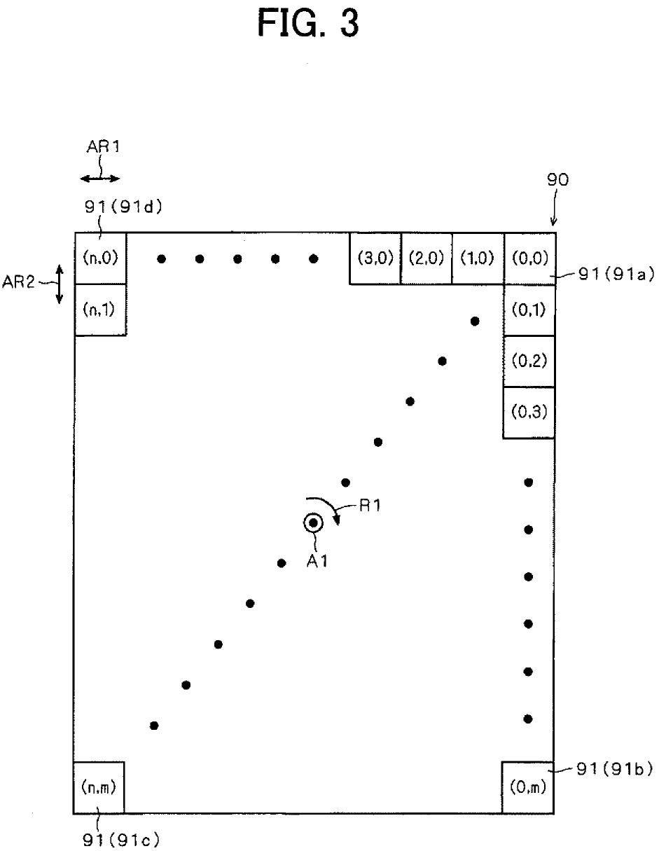

FIGS. 2 and 3 are diagrams schematically illustrating image data recorded on the recording sheet 90. Respective square cells on the recording sheet 90 correspond to dots 91 recorded by the printer 51 on the recording sheet 90. As regards a coordinate (x, y) shown in each square cell, the “x” and the “y” respectively represent positions of the dots 91 along a vertical direction (column direction) AR2 and a horizontal direction (row direction) AR1 prior to the rotation.

In the present preferred embodiment, bi-level image data (i.e., the output image data) corresponding to the respective dots 91 to be recorded on the recording sheet 90 are supplied to the printer 51 as a serial data row in sequence of (0, 0), . . . (0, m), (1, 0) . . . (1, m), . . . , (n, 0) . . . (n, m).

Dotted lines in FIG. 2 and solid lines in FIG. 3 illustrate the orientation of the recording sheet 90 after the recording sheet 90 illustrated by solid lines in FIG. 2 undergoes 90-degree rotation around an axis A1 in a rotational direction R1 (i.e., a clock-wise direction). Specifically, the 90-degree clock-wise rotation of the recording sheet 90 illustrated by the solid lines in FIG. 2 moves a dot 91a from the top left corner to the top right one, a dot 91b from the top right corner to the bottom right one, a dot 91c from the bottom right corner to the bottom left one, and a dot 91d from the bottom left corner to the top left one (see FIG. 3).

To record the same output image data as that illustrated in FIG. 2 on the recording sheet 90 that has undergone the 90-degree clock-wise rotation (see FIG. 3), each pixel data (data amount of 1 bit) composing the output image data has, as illustrated in FIG. 3 for example, to be fed into the printer 51 as a serial data row in sequence of (n, 0), . . . (0, 0), (n, 1), . . . (0, 1), . . . , (n, m) . . . (0, m). Thus, the image data has to be rotated so as for the respective pixel data to be supplied in such sequence.

The present preferred embodiment: (1) generates the intermediate image data from the input image data; (2) thereafter, generates the output image data from the intermediate image data so that the output image data rotated by 90 degrees from the input image data is obtained. These two steps of generation procedures will hereinafter be described.

(2.1. Procedures of Generating Intermediate Image Data from Input Image Data)

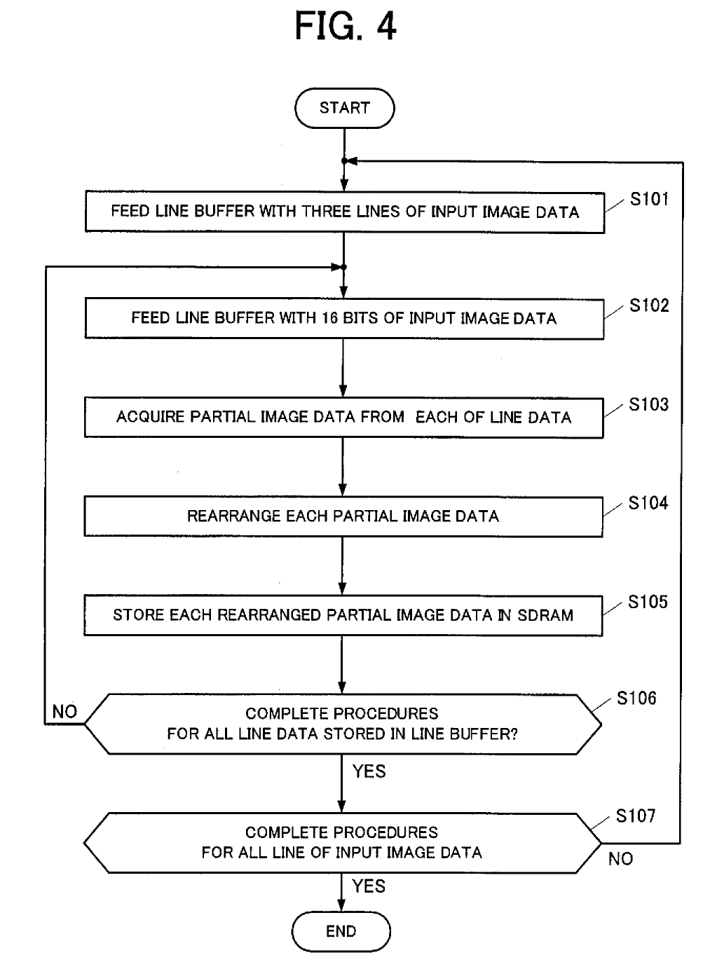

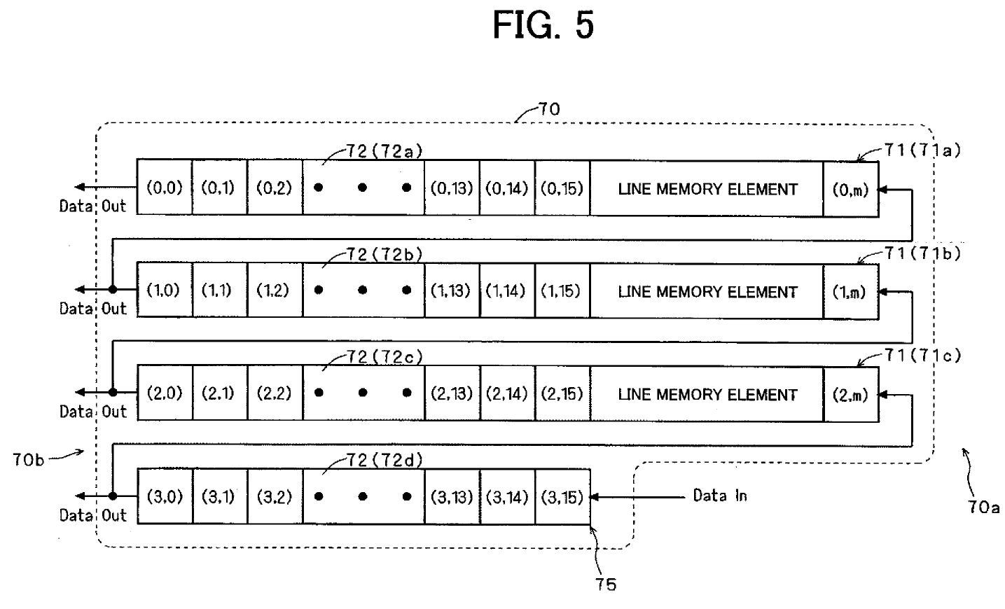

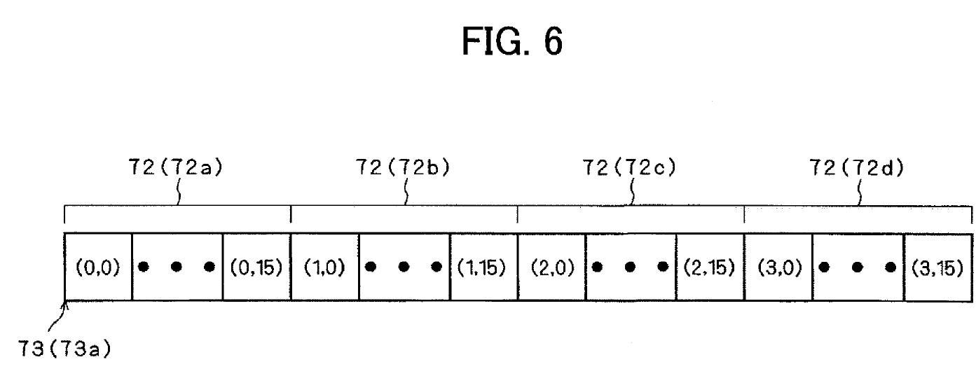

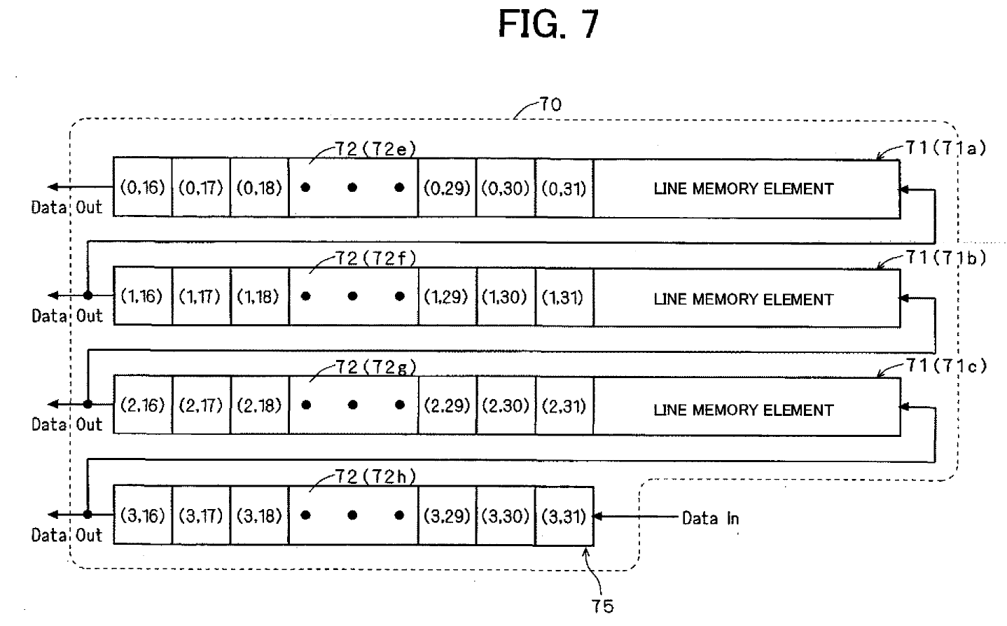

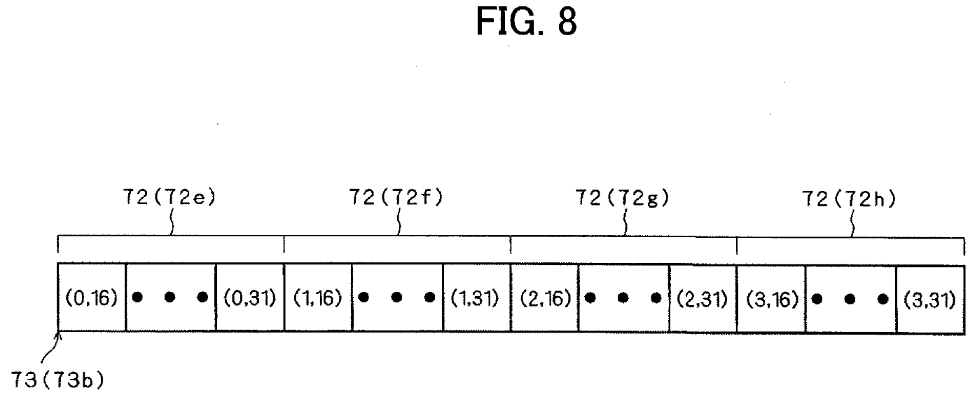

FIG. 4 is a flowchart illustrating procedures of generating the intermediate image data from the input image data. FIGS. 5 and 7 are diagrams illustrating examples of the line data stored in the input line buffer 70. FIGS. 6 and 8 are diagrams illustrating examples of to-be-stored data 73 (73a and 73b) to be stored in the minimum access unit in the SDRAM 16.

The procedures described here rearrange the input image data by the first image conversion unit 65 to generate the intermediate image data. Specifically, the first image conversion unit 65, first, writes adjacent 3 lines of the input image data, composed of a plurality of line data, in the input line buffer 70 (step S101).

As illustrated in FIG. 5, the input line buffer 70 includes at least three line memories 71a to 71c. Each one of the line memories 71a to 71c is composed of a First-In-First-Out (FIFO) memory. The output 70b of the line memory 71c is connected with the input 70a of the line memory 71b. Likewise, the output 70b of the line memory 71b is connected with the input 70a of the line memory 71a.

As illustrated in FIG. 5, the input line buffer 70 further includes a register 75, which has a memory capacity of 16 bits. The data stored in the register 75 can be supplied to the input 70a of the line memory 71c as well as the outside of the input line buffer 70.

The data, which has been fed into the input line buffer 70 and stored in the register 75, is sent in order of the register 75, and the line memories 71c, 71b, and 71a. The data fed into the line memories 71a, 71b and 71c can also be supplied from the respective outputs 70b to the outside of the input line memory 70.

It should be noted that the input line buffer 70, for example, reads in the bi-level image data, which has been decoded by the CODEC 31 as input image data.

Next, the first image conversion unit 65 makes the input line buffer 70 further read in 2 to the (k−2)-th power bits of the input image data (step S102). Line data adjacent to the line data stored in the line memory 71c is, thereby, stored in the register 75. In other words, part of the line data on the fourth line is read in the input line buffer 70.

The present preferred embodiment employs a DDR SDRAM as the SDRAM 16, and sets the value of k at “6”. The input line buffer 70, therefore, further reads in 16 bits of the input image data and stores the read data in the register 75 in step S102.

Next, the first image conversion unit 65 takes 16-bit (i.e., 2 to the (k−2)-th power-bit) data from each one of the adjacent four lines of line data stored in the line memories 71a to 71c and the register 75 to acquire four partial image data 72 (72a to 72d) in step S103. The partial image data 72a taken from the line memory 71a, for example, contains pixel data corresponding to 16 dots of the dots 91 illustrated in FIG. 2 arranged along the horizontal direction AR1 from the top left one.

Subsequently, the first image conversion unit 65 rearranges each of the four partial image data 72a to 72d acquired in step S103 in sequence of the data having been fed into the input line buffer 70 to generate the to-be-stored data 73 (73a) (step S104). As a result, the data 73a is rearranged in sequence of the partial image data 72a, 72b, 72c and 72d, as illustrated in FIG. 6.

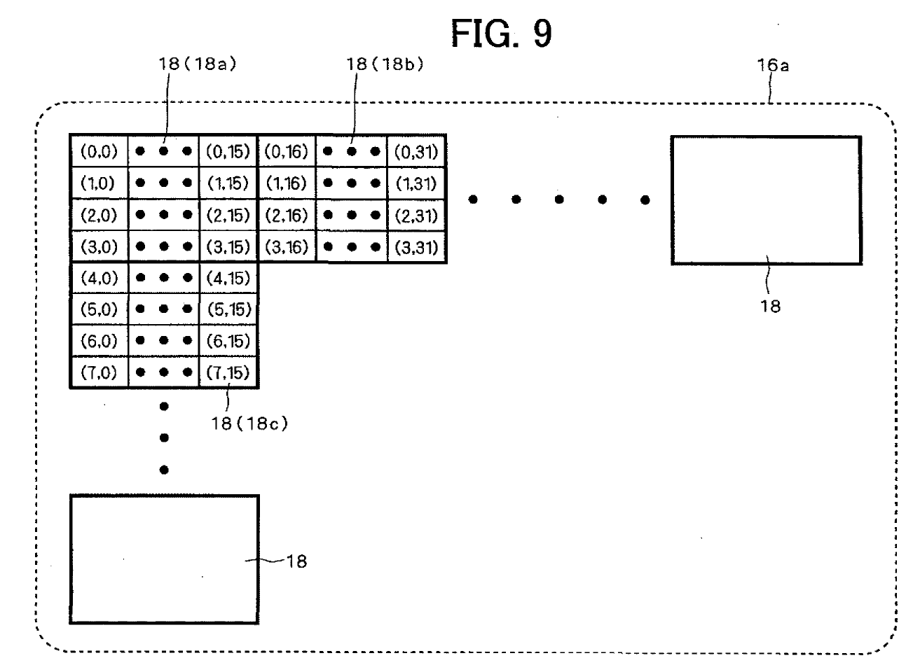

Next, the first image conversion unit 65 stores the rearranged partial image data 72a to 72d (i.e., the to-be-stored data 73) in the SDRAM 16 (step s105). FIG. 9 is a diagram illustrating an example of a logical address space in the SDRAM 16. As illustrated in FIG. 9, the data 73a is stored in a minimum access unit 18a.

The first image conversion unit 65 selects one bank from banks B1 to B4 to store each of the data 73 in the SDRAM, on the basis of after-mentioned order of the data read out from the SDRAM 16 to generate the output image data. The first image conversion unit 65, thereby, prevents delay in reading out the data due to the pre-charge of the SDRAM 16.

The procedures from the step S102 to S105 are iterated until the rearrangements for all the line data stored in the line memories 71a to 71c in the input line buffer 70 are completed (step S106).

Thus, the procedures from the step S102 to S105 are iterated to rearrange the 3 lines of line data stored in the line memories 71a to 71c of the line buffer 70 and the fourth line of line data stored in the register 75 one after another.

Once the rearrangements are completed for all the line data stored in the line memories 71a to 71c, the procedures return to the step S101. The next 3 lines of line data are, thereafter, read in by the input line buffer 70 to be stored in the line memories 71a to 71c, respectively. Subsequently, another data having a length of 2 to the (k−2)-th power bits is read in by the input line buffer 70 in step S102 (see FIG. 7).

Next, the to-be-stored data 73b acquired from the input line buffer 70 (see FIG. 8) is stored in the minimum access unit 18b in the SDRAM 16 (see FIG. 9) (step S105). These procedures from the steps S102 to S105 are iterated until the rearrangements for all the line data stored in the line memories 71a to 71c in the input line buffer 70 are completed (step S106).

When the procedures from the steps S101 to S106 are completed for all the lines of the input image data (step S107), the procedures of generating the intermediate image data 16a are completed.

(2.2. Procedures of Generating Output Image Data from Intermediate Image Data)

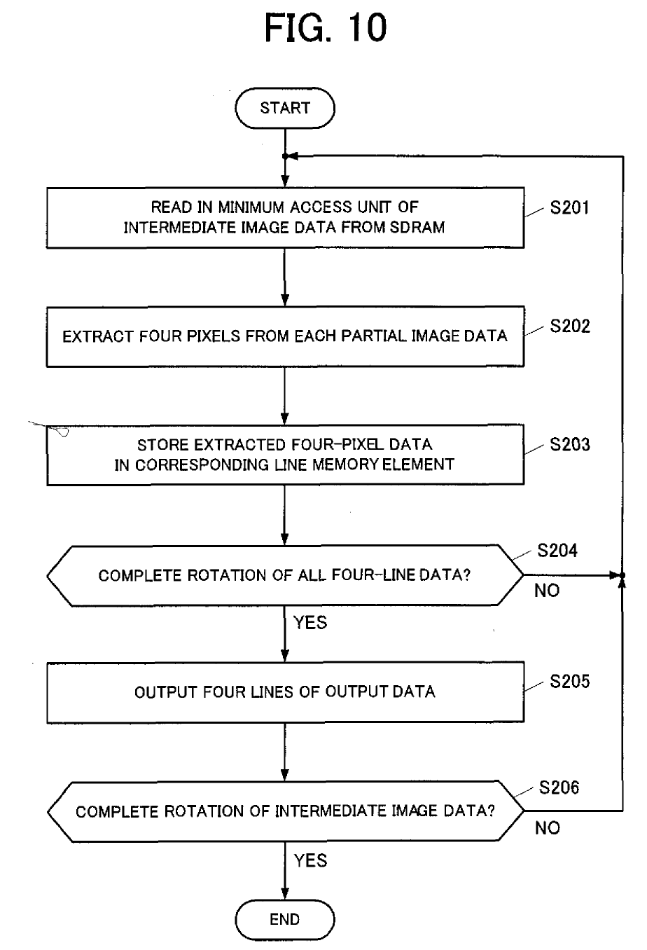

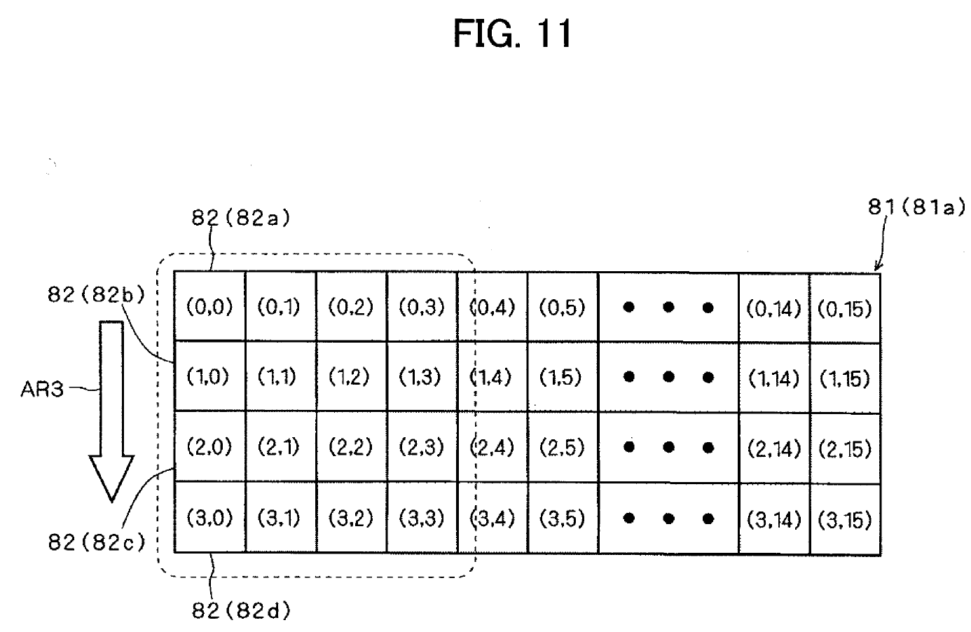

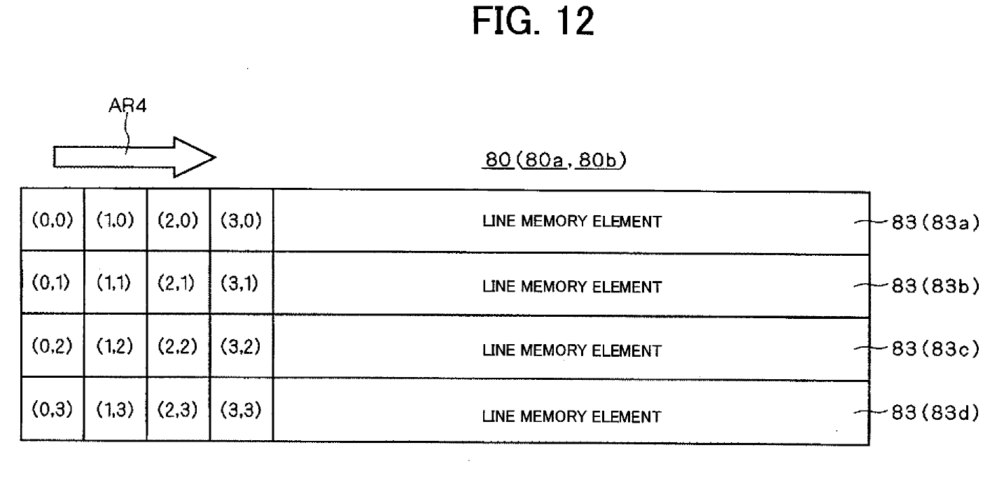

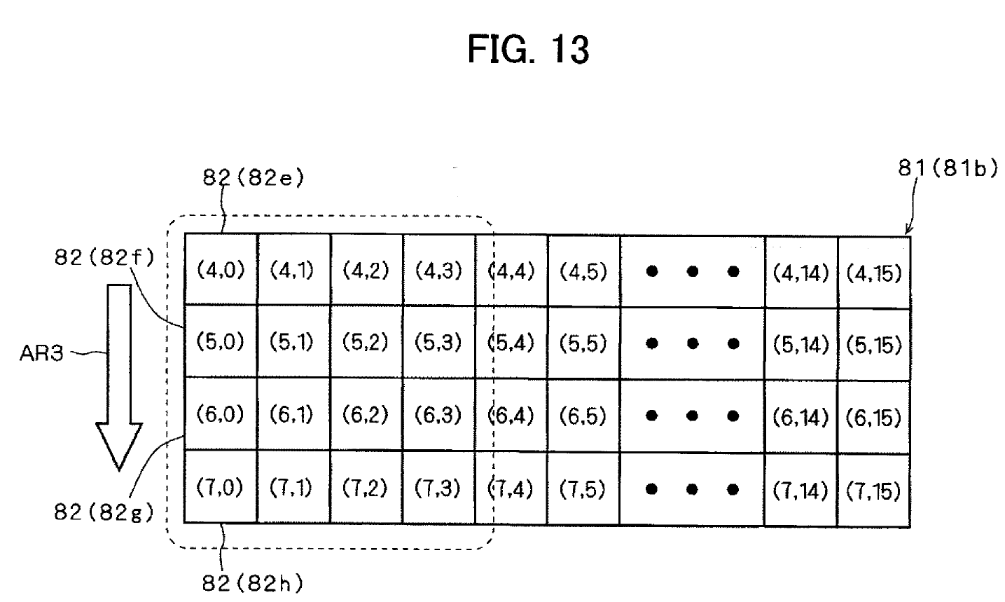

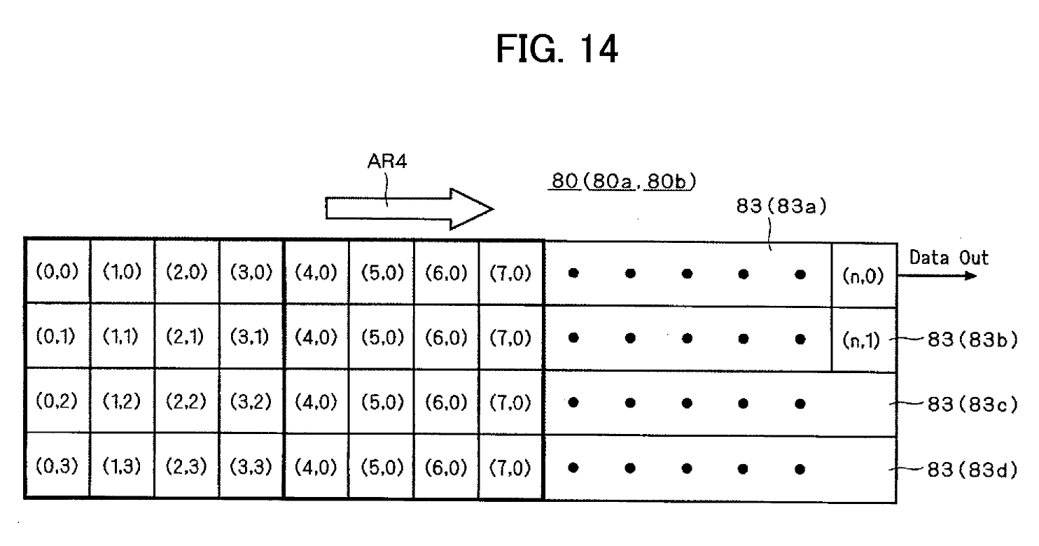

FIG. 10 is a flowchart illustrating procedures of generating the output image data from the intermediate image data. FIGS. 11 and 13 are diagrams illustrating examples of read-out data 81 (81a and 81b) readout from the SDRAM 16. FIGS. 12 and 14 are diagrams illustrating examples of the line data stored in the output line buffers 80.

The procedures described here rearrange the intermediate image data 16a stored in the SDRAM 16 by the second image conversion unit 66 to generate the output image data. Specifically, the second image conversion unit 66, first, reads out one of the minimum access units 18 (see FIG. 9) of the intermediate image data 16a stored in the SDRAM 16 (step S201). The second image conversion unit 66, for example, reads out the read-out data 81a (see FIG. 11) from the minimum access unit 18a (see FIG. 9).

Next, the second image conversion unit 66 extracts four-pixel data from each one of four partial image data 82a to 82d, which compose the read-out data 81a read out in step S201 (step S202).

If there has, for example, been generated the line data that corresponds to the uppermost row of the dots 91 (i.e., (n, 0), . . . (0, 0)) in FIG. 3 on the basis of the intermediate image data 16a, the part of each of the partial image data 82 (82a to 82d) surrounded by dashed lines is extracted.

The output line buffers 80 here have four line memories 83 (83a to 83d) as illustrated in FIG. 12. The second image conversion unit 66 stores the four-pixel data extracted in step S202 in the corresponding line memories 83 to thereby rotate the input image by 90 degrees (step S203).

The second image conversion unit 66, for example, stores the pixel data read out along a reading-out direction AR3 in the line memories 83 (83a to 83d) along a writing direction AR4 to thereby rotate the input image by 90 degrees.

More specifically, the second image conversion unit 66 stores the pixel data corresponding to the dots (0, 0), (1, 0), (2, 0) and (3, 0) in the line memory 83a. Likewise, the second image conversion unit 66 stores the pixel data corresponding to the dots (0, 1), (1, 1), (2, 1) and (3, 1) in the line memory 83b; the pixel data corresponding to the dots (0, 2), (1, 2), (2, 2) and (3, 2) in the line memory 83c; and the pixel data corresponding to the dots (0, 3), (1, 3), (2, 3) and (3, 3) in the line memory 83d.

The procedures from the steps S201 to S203 are iterated to thereby rotate the four lines of the read-out data 81 (step S204). After completing the rotation of the read-out data 81a, for example, the second image conversion unit 66 reads out the data 81b from the minimum access unit 18c (see FIG. 9) in the SDRAM 16 (step S201). Subsequently, the second image conversion unit 66 extracts new four-pixel data from each of the partial image data 82e to 82h (i.e., the part surrounded by dashed lines in FIG. 13) in step S202. The second image conversion unit 66 stores the extracted pixel data in the corresponding line memories 83a to 83d to thereby rotate the image (see FIG. 14) in step S203.

Once the four lines of the output image data are stored in the output line buffers 80, the second image conversion unit 66 outputs the acquired four lines of line data as a part of the output image data (step S205). In order for the printer 51 to record the output image data, the pixel data stored in the line memories 83a to 83d in the output line buffers 80 are supplied to the printer 51 as a serial data row in sequence of (n, 0) . . . (0, 0), (n, 1), . . . (0, 1), . . . (0, 2), . . . (0, 3).

After the procedures from the steps S201 to S205 for all the lines of the intermediate image data 16a (step S206), the procedures of generating the output image data is completed.

The method of the present preferred embodiment and that of conventional technique will now be compared with respect to the image rotation. The conventional method stores the input image data in the SDRAM 16 on the basis of the data row thereof without rearranging the input image data. Therefore, the conventional method effectively utilizes only 4 bits of the read-out data 81 (64 bits long) read out from any one of the minimum access units 18 to rotate the data by use of the four line memories 83 provided in the output line buffers 80. As a result, the method requires each one of the minimum access units 18 in the SDRAM to be accessed 16 times to read out the data.

On the other hand, the method of the present preferred embodiment rearranges the input image data first, and thereafter, stores the same in the SDRAM 16 as the intermediate image data 16a.

The method of the present preferred embodiment subjects 16 bits out of the read-out data 81 (64 bits long) to the rearrangements to generate the output image data from the intermediate image data 16a. As a result, the method improves the utilization efficiency of the read-out data 81. The method, for example, only has to read out the data from each one of the minimum access units 18 four times to implement the image rotation.

The method of the present preferred embodiment advantageously reduces the memory capacities of the input line buffer 70 and the output line buffers 80 used for the image rotation, and consequently, further reduces costs for manufacturing the image processing device.

(3. Modifications)

Although the preferred embodiment has been described, the present invention is not be restricted to the aforementioned preferred embodiment, but includes various modified embodiments.

(1) The present preferred embodiment employs DDR SDRAM as the SDRAM 16, whereas the present invention does not restrict the SDRAM 16 to the DDR SDRAM. For example, an SDRAM having a 32-bit wide minimum access unit or a DDR2 SDRAM having 128-bit wide one can also be employed as the SDRAM 16.

(2) In the present preferred embodiment, the input line buffer 70 has been described to include three line memories 71a to 71c and the register 75, whereas the input line buffer 70 is not limited to those. The register 75 can, for example, be replaced with an almost the same line memory as the line memories 71a to 71c.

While the present invention has been described with respect to preferred embodiments thereof, it will be apparent to those skilled in the art that the disclosed invention may be modified in numerous ways and may assume many embodiments other than those specifically set out and described above. Accordingly, it is intended by the appended claims to cover all modifications of the present invention that fall within the true spirit and scope of the present invention.

What is claimed is:

1. An image processing device comprising:
an SDRAM including a minimum access unit, a data amount of the minimum access unit being 2 to a k-th power bits;
an input line buffer capable of storing input image data on a four lines by four lines basis;
a first image conversion unit that generates intermediate image data on a basis of the input image data stored in the input line buffer to store the generated intermediate image data in the SDRAM;
an output line buffer including four line memory elements and being capable of storing output image data on a four lines by four lines basis; and
a second image conversion unit that generates four lines of the output image data on a basis of the intermediate image data stored in the SDRAM to make the output line buffer output the output image data on a four lines by four lines basis.

2. The image processing device according to claim 1, wherein
the first image conversion unit takes 2 to a (k−2)-th power-bit data from each of four lines of line data stored in the input line buffer out of the input image data to acquire four partial image data.

3. The image processing device according to claim 2, wherein
the first image conversion unit rearranges each of the acquired four partial image data in sequence of the same data having been fed into the input line buffer.

4. The image processing device according to claim 3, wherein
the first image conversion unit stores each of the rearranged four partial image data in the SDRAM as the minimum access unit.

5. The image processing device according to claim 1, wherein
the second image conversion unit reads out the intermediate image data stored in the SDRAM on a minimum access unit by minimum access unit basis.

6. The image processing device according to claim 5, wherein
the second image conversion unit stores four-pixel data extracted from each of the four partial image data, which compose the read out data, in the corresponding line memory element to rotate the input image data by 90 degrees.

7. The image processing device according to claim 6, wherein
the second image conversion unit outputs the acquired four lines of line data as a part of the output image data.

8. The image processing device according to claim 1, wherein
the SDRAM is a DDR SDRAM, and the data amount of the minimum access unit is 2 to a 6-th power bits.

9. The image processing device according to claim 1, wherein
the output line buffer includes a first output line buffer and a second output line buffer, the second output line buffer is capable of outputting data while data is written in the first output line buffer, and the first output line buffer is capable of outputting data while data is written in the second output line buffer.

10. An image processing device comprising:
means for storing data including a minimum access unit,
a data amount of the minimum access unit being 2 to a k-th power bits;
means for storing input image data on a four lines by four lines basis;
means for generating intermediate image data on a basis of every four lines of the input image data;
means for storing output image data on a four lines by four lines basis, including four line memory elements; and
means for generating four lines of the output image data on a basis of the intermediate image data.

11. The image processing device according to claim 10, further comprising;
a sixth means for taking 2 to a (k−2)-th power-bit data from each of four lines of line data.

12. The image processing device according to claim 11, further comprising:
means for rearranging each of the acquired four partial image data in order of input of the data.

13. The image processing device according to claim 12, further comprising:
means for storing each of the rearranged four partial image data.

14. The image processing device according to claim 10, further comprising:
means for reading out the intermediate image data by minimum access unit basis.

15. The image processing device according to claim 14, further comprising:
means for storing four-pixel data extracted from each of the four partial image data, which compose the read out data, in the corresponding line memory element to rotate the input image data by 90 degrees.

16. The image processing device according to claim 15, further comprising:
means for outputting the four lines of line data as a part of the output image data.

17. An image processing method comprising the steps of:
preparing an SDRAM including a minimum access unit, a data amount of the minimum access unit being 2 to a k-th power bits;
preparing an input line buffer capable of storing input image data on a four lines by four lines basis;
preparing an output line buffer including four line
memory elements and being capable of storing output image data on a four lines by four lines basis;
taking 2 to a (k−2)-th power-bit data from each one line of four-line data stored in the input line buffer out of the input image data to acquire four partial image data;
rearranging each of the acquired four partial image data in sequence of the same data having been fed into the input line buffer;
storing each of the rearranged four partial image data in the SDRAM as the minimum access unit;
reading out an intermediate image data stored in the SDRAM on a minimum access unit to minimum access unit basis;
storing four-pixel data extracted from each of the four partial image data, which compose the read out data, in the corresponding line memory element to rotate the input image data by 90 degrees; and
outputting the acquired four lines of line data as part of the output image data.

18. The image processing method according to claim 17, wherein
the output line buffer includes a first output line buffer and a second output line buffer, and the method further comprises the steps of:
operating the second output line buffer to output data while writing data in the first output line buffer; and
operating the first output line buffer to output data while writing data in the second output line buffer.
